(19) United States
(12) Patent Application Publication
(10) Pub. No.: US 2026/0313426 A1
(43) Pub. Date: Oct. 8, 2026

(54) ENHANCED MIXING TRAINING FOR ARTIFICIAL INTELLIGENCE AND MACHINE LEARNING PROCESSING OF WIRELESS SIGNALS

(71) Applicant: Telefonaktiebolaget LM Ericsson (publ), Stockholm (SE)

(72) Inventors: Jung-Fu CHENG, Fremont, CA (US); Atieh RAJABI KHAMESI, Newark, CA (US)

(21) Appl. No.: 19/483,491

(22) PCT Filed: May 14, 2024
(86) PCT No.: PCT/SE2024/050459

§ 371 Date: Nov. 11, 2025

Related U.S. Application Data
(60) Provisional application No. 63/502,210, filed on May 15, 2023.

(51) Int. Cl. H04W 24/10; H04L 41/16

(52) U.S. Cl. CPC H04W 24/10; H04L 41/16

(57) ABSTRACT

A method in a node associated with a network is described. The method includes receiving wireless signal measurement data, formatting the received wireless signal measurement data as a plurality of channels, generating augmented training data by transforming the plurality of channels according to a mixup procedure, the mixup procedure being associated with a plurality of parent example labels and an interpolation ratio, and training a machine learning (ML) model based on the augmented training data. The training is based on a loss function based on an ML model output, the plurality of parent example labels, and the interpolation ratio.

### TECHNICAL FIELD

The present disclosure relates to wireless communications, and in particular, to configurations for supporting enhanced mixup training for artificial intelligence and/or machine learning (AI/ML) processing of wireless signals.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

### AI/ML Models and the Need for Retraining or Retuning for Operating Environment Changes

AI and ML have been investigated as promising tools to optimize the design of the air-interface in wireless communication networks by both academia and industry. Example use cases include using autoencoders for channel state information (CSI) compression to reduce the feedback overhead and improve channel prediction accuracy, using deep neural networks for classifying line of sight (LoS) and non LoS (NLoS) conditions to enhance the positioning accuracy, using reinforcement learning for beam selection at the network side and/or the WD side to reduce the signaling overhead and beam alignment latency, and using deep reinforcement learning to learn an optimal precoding policy for complex multiple input multiple output (MIMO) precoding problems.

Building an AI/ML model includes several development steps where the actual training of the AI model is just one step in a training pipeline. One aspect of AI/ML development is AI/ML model lifecycle management. An example AI/ML model lifecycle management is illustrated in the diagram of FIG. 1, including a training pipeline 1 and an inference pipeline 2. The AI model lifecycle management typically includes:
A training (re-training) pipeline 1, including one or more of:
   Data ingestion (Step S2), which may include gathering raw (training) data from a data storage. After data ingestion, there may also be a step that controls the validity of the gathered data.
   Data pre-processing (Step S4), which may include some feature engineering applied to the gathered data, e.g., it may include data normalization and possibly a data transformation required for the input data to the AI/ML model.
   Perform the model training steps (Step S6).
   Model evaluation (Step S8), which may include benchmarking the performance to some baseline. The iterative steps of model training and model evaluation continues until the acceptable level of performance is achieved.
   Model registration (Step S10), which may include registering the AI/ML model, including any corresponding AI/ML-meta data that provides information on how the AI/ML model was developed, and possibly AI/ML model evaluations and performance outcomes.
A deployment stage (S11) to make the trained(or re-trained) AI/ML model part of the inference pipeline 2.
An inference pipeline 2, including one or more of:
   Data ingestion (Step S12), which may include gathering raw (inference) data from a data storage.
   Data pre-processing stage (Step S14), which may be typically identical or similar to corresponding processing that occurs in the training pipeline.
   Model operational (Step S16), which may refer to using the trained and deployed model in an operational mode.
   Data & model monitoring (Step S18), which may refer to validating that the inference data are from a distribution that aligns well with the training data, as well as monitoring model outputs for detecting any performance, or operational, drifts.
A drift detection stage (Step S20) that informs other entities or processes (e.g., the training pipeline 1) about any drifts in the model operations.

If the operating environment drifts too much from that of the training dataset, the model may need to be retrained or retuned in order to operate in this new environment properly.

### WD Positioning Based on Wireless Signals

In the following disclosure, WD positioning based on wireless signals is used as a nonlimiting example of applying AI/ML models to process wireless signals.

WD positioning is a feature of location-based services, which has a variety of commercial applications from entertainment to healthcare, from geo-targeting advertisement to smart factories and smart warehouses. Moreover, with the advent of extended Reality (XR), WD positioning is becoming even more important. The requirements for positioning accuracy vary among different applications, for example, from the centimeter level for industrial applications to a few meters' accuracy for emergency calls.

In 3GPP TS 36.305 V18.0.0, a list of positioning techniques are provided. In the following, a few representative methods are described:

Enhanced Cell ID: This technique adopts the cellular network's knowledge such as cell identifier (ID) and more information about the serving cell of the WD to determine the position.

Assisted Global Navigation Satellite System (GNSS): The WD retrieves GNSS information to determine its position.

Observed Time Difference of Arrival (OTDOA): In this technique, the WD estimates the time difference of reference signals from different base stations and report this information to the network for multilateration.

Uplink Time Difference of Arrival (UTDOA): This technique uses the received signals from the WD at multiple known positions, e.g., network nodes, gNBs, etc., to estimate the relative TOA at different network nodes 16 (transmission and reception points (TRPs) 17) and then perform the multilateration computation at the network side to obtain an estimated WD position.

Example general positioning related reports include at least one of the following:
Timing of arrival (ToA) of a downlink (DL) signal or an uplink (UL) signal;
Timing difference of arrival (TDoA) of DL signals or UL signals, for example, DL reference signal time difference (DL RSTD), and UL Relative Time of Arrival (T_{UL-RTOA});
Timing Advance (TADV);
DL or UL angle of departure (AoD);
DL or UL angle of arrival (AoA);
Reference signal received power (RSRP), for example, DL PRS reference signal received power (DL PRS-RSRP), and UL SRS reference signal received power (UL SRS-RSRP);
Reference signal received path power (RSRPP), for example, DL PRS reference signal received path power (DL PRS-RSRPP), and UL SRS reference signal received path power (UL SRS-RSRPP);
Cell ID and network node (TRP) related information (e.g., RS resource and/or resource set ID);
Carrier phase difference;
Round-trip time (RTT) measurement, which is obtained by combining network node (gNB) Rx-Tx time difference information and WD Rx-Tx time difference information;

Two broad positioning scenarios may be considered:

In a first network based scenario, it may be assumed that such positioning related reports may be generated by a WD, a base station (BS) (network node), or a Transmit/Receive Point (TRP). These positioning related reports may be reported to a centralized node in the network for determining the WD's position.

For instance, the network, such as via a network node, can configure the WD to transmit uplink (UL) sounding reference symbols (SRS) and configure more than one TRP to receive the SRS signals. Each of the TRPs processes the received signals to generate reports that can be used by the network to determine the WD position.

For instance, the WD may receive downlink (DL) positioning reference symbols (PRS) from a set of TRPs. The WD processes these received signals to generate reports that can be used by the network to determine the WD location.

In a second WD based scenario, it may be assumed that positioning related reports may be generated by a WD. These positioning related reports may be further utilized by the WD to determine its own location.

For instance, the WD may receive downlink (DL) positioning reference symbols (PRS) from a set of TRPs. The WD processes these received signals to generate reports that can be further used to determine the WD's own location.

Existing signal processing techniques can generally be applied by the WD, BS or TRP to generate positioning related reports in operating environments with enough line-of-sigh (LoS) links. Time of arrival (ToA) may be used as an example. With the known speed of the radio wave, the ToA estimates may equivalently be converted to the 3D distance estimates between the TX and RX nodes. However, it should be clear to one skilled in the art that the teachings herein are not limited to timing-based reports. Rather the teachings herein may be applied to any of the other positioning related reports, for example, received power measurements or angle measurements. In a radio environment, a transmitted signal may travel directly from the transmitter to the receiver resulting in a line-of-sight (LoS) path. However, the transmitted signal may also be reflected or scattered by the environment resulting in multiple non-line-of-sight (NLoS) paths. For example, FIG. 2 is a schematic diagram which illustrates an example multipath radio environment between a WD 3 and two TRPs 4a and 4b. For TRP 4a, a LoS path exists between the WD 3's transmitter and TRP 4a's receiver. For TRP 4b, however, only a NLoS paths exist between the WD 3's transmitter and TRP 4b's receiver because of the blockers (i.e., reflectors 5a, 5b, 5c, and 5d) in the environment.

For a LoS path, conventional signal processing algorithms may be applied to obtain accurate ToA estimates as the timing of the first observed path in the received signal. For these LoS paths, the ToAs represent the correct representation of the 3D distance between the TX and RX, d_{3D}, via the speed of the radio wave, c:

$${ToA}_{Los} = \frac{{d}_{3 D}}{c}$$

However, for NLoS paths as illustrated in FIG. 2, the radio wave travels along indirect paths to arrive at the RX via potentially more than one reflection. Hence, the straightforward estimate of the ToA as the first observed path in the received signal may give incorrect estimates of the 3D distance between TX and RX:

$${ToA}_{NLos} > \frac{{d}_{3 D}}{c}$$

For example, FIGS. 3 and 4 show two graphs which illustrate (a) an example first observed path ToA, τ_{obs}, as the delay of the first path in the received channel impulse responses (CIRs) for a LOS and(b) a NLoS example in a InF-DH {40%, 2m, 2m} radio 25 environment, according to the following parameters:

$$LoS example {τ}_{obs} = {τ}_{dp} = 18.5 taps \qquad ( a )$$

$$NLoS example {τ}_{obs} = 79.4 > {τ}_{dp} = 30.2 taps . \qquad ( b )$$

Using these over-estimated ToAs or equivalently 3D distances in conventional positioning solutions based on triangulation computation may result in incorrect localization of the WD position.

### AI/ML Assisted Positioning

In addition, AI/ML models may be adopted to infer the correct direct path ToA from the received signals regardless of whether the signals arrive via LoS or NLoS paths:

$${ToA}_{DP} {=}^{Δ} \frac{{d}_{3 D}}{c}$$

That is, the direct path ToA is the time for the radio wave to travel directly from the TX to the RX ignoring any potential blockers in between. The estimated direct path ToA can then be used in a conventional positioning algorithm to determine the WD position.

### AI/ML Direct Positioning

Alternatively, AI/ML models may also be adopted to infer the WD position directly from the received signals regardless of whether the signals arrive via LoS or NLoS paths.

Such types of AI/ML models perform what is also known as fingerprinting of the radio environment. That is, via training with enough data, the AI/ML models may obtain an understanding of the correspondence of the received signals and the radio environment.

If the radio environment remains static or changes only slightly, the AI/ML models can continue to produce correct or correct enough ToA estimates for the conventional positioning algorithms to compute WD positions within accuracy requirement. However, the AI/ML models may produce inadequate ToA estimates for accurate positioning if the radio environment changes too much over time. It therefore may be useful to monitor the AI/ML model performance over time to identify whether updating or retraining of the AI/ML models is needed.

As a further example, a 3GPP indoor factory (InF) model is illustrated in the schematic diagram of FIG. 5 as a nonlimiting example of a deployment. In this scenario, a quantity of 18 TRPs 4 are deployed in the factory with TRP 4 locations known at the network. With 60% clutter density and clutter height and width of 6 m and 2 m, respectively, this indoor factory scenario has less than 1% LoS probability from a WD to any TRPs 4 (e.g., network nodes, base stations, etc.).

### Data Augmentation

In general, AI/ML models may achieve higher performance (e.g., lower WD positioning errors for the WD positioning problem) when the models are trained with more samples. However, for the wireless signal application cases, each sample may include:
The multi-dimensional received signal values corresponding to, for example, (1) time or frequency domain sampling grids, (2) multiple antenna ports of a transmit and receive point (TRP), and(3) multiple TRPs.
   For the 3GPP InF use case shown in the example of FIG. 5, a received signal sample typically consists of 256×18×2 values, where 256 corresponds to the number of time domain taps, 18 corresponds to the number of TRPs 4, and 2 corresponds to the number of antenna ports per TRP 4 in this example. Note that some TRP configurations may include any number of antenna ports per TRP 4, e.g., 1, 2, 4, 5, 8, 16, etc., and the teachings herein are not limited to TRPs 4 of 2 antennas. Note further that each value can be a real value for the power delay profile (PDP) sample case or a complex value (with in-phase and quadrature values) for the channel impulse response (CIR) sample case. For the CIR sample case, the received signal sample may need to consist of 18×256×4 values if the AI/ML models cannot process complex values directly or natively.
The ground truth values of either the WD 3 position or the direct path delays corresponding to the received wireless signal sample.

Hence, it may be costly and time-consuming to collect, transfer, and store very large datasets for AI/ML wireless signal application cases, in existing systems.

For the computer vision field, machine learning researchers have constructed data augmentation techniques to create more variations of the same images for training the computer vision AI/ML models.

c-mixup

Existing data augmentation techniques developed for classification problems, where the AI/ML models may only need to choose between a finite set of possible output values, may not be appropriate for the WD positioning problem, which may be, intrinsically, a regression problem, e.g., because the AI/ML models may need to be able to output continuous values for the potential WD positions.

One data augmentation technique specifically designed for regression problems is the C-Mixup training approach. The algorithm generates new training examples by linearly combining pairs of examples and their corresponding labels. The algorithm is a simple but effective technique for generating synthetic training data, which may assist in improving the accuracy and robustness of deep learning models on regression problems. The C-Mixup algorithm may be usable for improving the accuracy of various machine learning models, particularly in the pose/angle estimation images estimation tasks. An example C-Mixup algorithm is as follows:

Let xᵢ, xⱼ be two input examples, and yᵢ, yⱼ be their corresponding labels, respectively, where (xᵢ, yᵢ) and(xⱼ, yⱼ) may refer to parent examples. In c-mixup training, a mixup input and a mixup target may be generated as follows:
Mixup input:

$$\tilde{x} = λ \cdot {x}_{i} + ( 1 - λ ) \cdot {x}_{j}$$

Mixup target:

$$\tilde{y} = λ \cdot {y}_{i} + ( 1 - λ ) \cdot {y}_{j}$$

The mixup input and the mixup target are hence linear interpolations of parent examples using a random interpolation ratio λ∈[0, 1]. As a nonlimiting example, the random interpolation ratio is drawn from a Beta distribution with parameters α, i.e., λ~Beta (α, α).

In the C-Mixup algorithm, closer pairs of examples are selected with higher probability to combine. Specifically, given an example (xᵢ, yᵢ), C-Mixup uses a symmetric Gaussian kernel to obtain the sampling probability P((xⱼ, yⱼ)|(xᵢ, yᵢ) for another (xⱼ, yⱼ) example to be mixed as follows:

$$P ( ( {x}_{j} , {y}_{j} ) \vert ( {x}_{i} , {y}_{i} ) ) ∝ exp ( - \frac{d ( i , j )}{2 {σ}^{2}} )$$

where d(i, j) represents the distance between the examples (xᵢ, yᵢ), and(xⱼ, yⱼ), and σ describes the bandwidth.

To find distance between the examples, C-Mixup leverages the labels, i.e.,

$$d ( i , j ) = d ( {y}_{i} , {y}_{j} ) = {‖ {y}_{i} - {y}_{j} ‖}_{2}^{2} {=}^{Δ} {\sum }_{k = 1}^{n} {\vert {y}_{i} [ k ] - {y}_{j} [ k ] \vert}^{2}$$

where yᵢ and yⱼ are vectors with continuous values. The dimension of label is typically much smaller than that of the input feature, therefore this technique may be favorable since it reduces computational costs.

By repeating this process for each example in the training set, the C-Mixup algorithm generates a set of augmented examples and their corresponding labels that can then be used for training deep learning models and/or model monitoring.

FIG. 6 shows an example C-mixup training procedure, wherein inputs xᵢ, xⱼ, yᵢ, and yⱼ, are provided to the C-mixup function 7 and to loss function 9. The mixup inputs ã are fed into a machine learning model 8. Let ŷ denote the output of the machine learning model 8. The machine learning model 8 may be optimized by modifying its internal parameters such that the loss function 9 is minimized as much as possible.

For some C-mixup training algorithms, the loss function may be defined as a function of:
The model output ŷ; and
The mixup target \tilde{y}.

That is, the C-mixup loss function takes the form of:

$$ℒ ( \hat{y} , \hat{y} )$$

More specifically, in some existing C-mixup training systems, the loss function is a mean square error distance (also known as L2 distance):

$$ℒ ( \hat{y} , \hat{y} ) {=}^{Δ} {\sum }_{k = 1}^{n} {\vert {\hat{y}}_{i} [ k ] - \tilde{y} [ k ] \vert}^{2}$$

Such loss functions may force the machine learning model to learn outputs that are closer to the mixup target, which is distinct from either of the parent example labels.

For example, a C-mixup data augmentation may include performing the following steps repeatedly for different training data samples:
Select a pair of parent examples randomly with pairing probability inverse proportional to their differences.
Determine a random interpolation ratio A.
Determine a mixup input ã and a mixup target \tilde{y}.
Determine a model output ŷ from a machine learning model using the mixup input.
Determine a loss as a function of the model output ŷ and the mixup target \tilde{y}.
Determine adjustments to the parameters of machine learning model to reduce the loss.

Existing data augmentation techniques developed for classification problems typically do not work as well for regression problems/applications such as the WD positioning problem/application.

C-mixup training is a data augmentation technique designed for regression problems/applications, but existing C-mixup training techniques have typically provided only limited improvements for deep learning models, e.g., for WD positioning.

Thus, existing systems lack adequate configurations for supporting mixup training for AI/ML processing of wireless signals.

### SUMMARY

Some embodiments advantageously provide methods, systems, and apparatuses for supporting enhanced mixup training for AI/ML processing of wireless signals.

For example, some embodiments provide enhanced loss functions to add to the c-mixup training technique, e.g., as a data augmentation technique, to achieve more performance improvements for deep learning models.

For example, in some embodiments, instead of using only the model output ŷ and the mixup target y in the calculation of the loss function, the labels of the parent examples as well as the interpolation ratio may be considered in the loss function.

Embodiments of the present disclosure provide data augmentation (e.g., mixup training) operations that may enable AI/ML models to be trained to very high WD positioning accuracy with limited dataset sizes.

According to one aspect, a method in a node associated with a network is described. The method includes receiving wireless signal measurement data, formatting the received wireless signal measurement data as a plurality of channels, generating augmented training data by transforming the plurality of channels according to a mixup procedure, the mixup procedure being associated with a plurality of parent example labels (e.g., labels yᵢ and yⱼ) and an interpolation ratio, and training a machine learning (ML) model based on the augmented training data. The training is based on a loss function based on an ML model output, the plurality of parent example labels, and the interpolation ratio.

In some embodiments, the wireless signal measurement data is associated with one or more of at least one network node, at least one transmission and reception point (TRP), and at least one wireless device.

In some other embodiments, the received wireless signal measurement data includes at least a wireless signal sample, and formatting the received wireless signal measurement data includes formatting the at least wireless signal sample based on a two-dimensional data representation comprising at least three parameters.

In some embodiments, the at least three parameters includes a first parameter, a second parameter, and a third parameter. The first parameter corresponds to a plurality of time domain taps, the second parameter corresponds to a plurality of transmission and reception points (TRPs), and the third parameter corresponds to a quantity of channels of the plurality of channels.

In some other embodiments, formatting the received wireless signal measurement data includes combining two of the at least three parameters and obtaining a single-dimension data representation using the combination.

In some embodiments, the loss function corresponds to a linear interpolation of a plurality of losses associated with the ML model output and the plurality of parent example labels.

In some other embodiments, the plurality of parent example labels corresponds to a plurality of pairs of parent example labels, and generating augmented training includes randomly selecting a pair of the plurality of pairs of parent example labels with a pairing probability. The pairing probability is inversely proportional to a difference between a first element of the pair and a second element of the pair.

In some embodiments, generating augmented training further includes one or more of determining the interpolation ratio, where the interpolation ratio being a random interpolation ratio λ, determining a mixup input, ã, determining a model output, ŷ, from the ML model using the mixup input, \tilde{x}, determining the loss function as a function of the model output, ŷ, a first parent example label, yᵢ, and a second parent example label, yⱼ, and the random interpolation ratio λ, and determining adjustments to one or more parameters of ML model to reduce loss.

In some other embodiments, a loss associated with the loss function is a linear interpolation of losses individually considering the model output and at least one parent example label.

In some embodiments, the method further includes performing at least one action based on the trained ML model.

In some other embodiments, the node is one of a network node, a management node, and a wireless device.

According to another aspect, a node associated with a network is described. The node is configured to receive wireless signal measurement data, format the received wireless signal measurement data as a plurality of channels, generate augmented training data by transforming the plurality of channels according to a mixup procedure. The mixup procedure is associated with a plurality of parent example labels and an interpolation ratio. In addition, the node is configured to train a machine learning (ML) model based on the augmented training data. The training is based on a loss function based on an ML model output, the plurality of parent example labels, and the interpolation ratio.

In some embodiments, the wireless signal measurement data is associated with one or more of at least one network node, at least one transmission and reception point (TRP), and at least one wireless device.

In some other embodiments, the received wireless signal measurement data includes at least a wireless signal sample, and formatting the received wireless signal measurement data includes formatting the at least wireless signal sample based on a two-dimensional data representation comprising at least three parameters.

In some embodiments, the at least three parameters includes a first parameter, a second parameter, and a third parameter. The first parameter corresponds to a plurality of time domain taps, the second parameter corresponds to a plurality of transmission and reception points (TRPs), and the third parameter corresponds to a quantity of channels of the plurality of channels.

In some other embodiments, formatting the received wireless signal measurement data includes combining two of the at least three parameters and obtaining a single-dimension data representation using the combination.

In some embodiments, the loss function corresponds to a linear interpolation of a plurality of losses associated with the ML model output and the plurality of parent example labels.

In some other embodiments, the plurality of parent example labels corresponds to a plurality of pairs of parent example labels, and generating augmented training includes randomly selecting a pair of the plurality of pairs of parent example labels with a pairing probability. The pairing probability is inversely proportional to a difference between a first element of the pair and a second element of the pair.

In some embodiments, generating augmented training further includes one or more of determining the interpolation ratio, the interpolation ratio being a random interpolation ratio λ, determining a mixup input, \tilde{x}, determining a model output, ŷ, from the ML model using the mixup input, determining the loss function as a function of the model output, ŷ, a first parent example label, yᵢ, and a second parent example label, yⱼ, and the random interpolation ratio λ, and determining adjustments to one or more parameters of ML model to reduce loss.

In some other embodiments, a loss associated with the loss function is a linear interpolation of losses individually considering the model output and at least one parent example label.

In some embodiments, the node is further configured to perform at least one action based on the trained ML model.

In some other embodiments, the node is one of a network node, a management node, and a wireless device.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a flowchart illustrating example training and inference pipelines, and their interactions within a model lifecycle management procedure;

FIG. 2 is a schematic diagram which illustrates an example multipath radio environment between a WD and two TRPs;

FIG. 3 shows a graph which illustrates an example first observed path ToA, τ_{obs}, associated with a LOS;

FIG. 4 shows another graph which illustrates the example first observed path ToA, τ_{obs}, associated with a NLoS example in a InF-DH {40%, 2m, 2m} radio environment;

FIG. 5 is a schematic diagram illustrating an example 3GPP indoor factory (InF) model with 18 TRPs deployed at locations known at the network;

FIG. 6 shows an example mixup training technique;

FIG. 7 is a schematic diagram of an example network architecture illustrating a communication system connected via an intermediate network to a host computer according to the principles in the present disclosure;

FIG. 8 is a block diagram of a host computer communicating via a network node with a wireless device and/or a management node over an at least partially wireless connection according to some embodiments of the present disclosure;

FIG. 9 shows an example node according to some embodiments of the present disclosure;

FIG. 10 is a flowchart of an example process in a management node for supporting configurations for mixup training for AI/ML processing of wireless signals according to some embodiments of the present disclosure;

FIG. 11 is a flowchart of an example process in a network node for supporting configurations for mixup training for AI/ML processing of wireless signals according to some embodiments of the present disclosure;

FIG. 12 is a flowchart of an example process in a wireless device for supporting configurations for mixup training for AI/ML processing of wireless signals according to some embodiments of the present disclosure;

FIG. 13 is a flowchart of an example process in a node according to some embodiments of the present disclosure;

FIG. 14 is a flowchart illustrating an example mixup training technique according to some embodiments of the present disclosure; and

FIG. 15 is a graph illustrating example cumulative distribution functions of 2D position error of a model trained with mixup training techniques according to embodiments of the present disclosure.

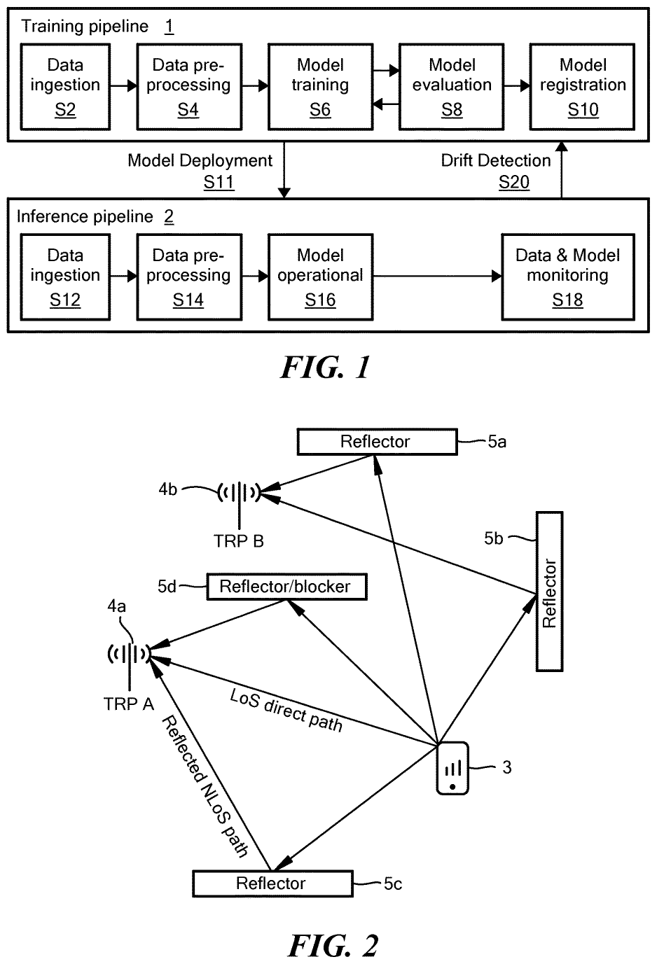

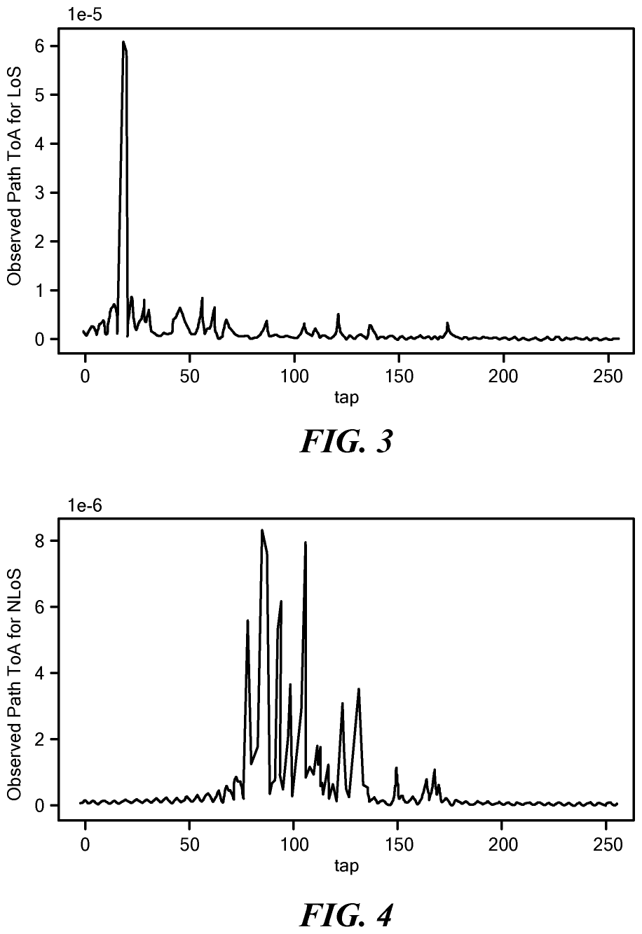

### DETAILED DESCRIPTION

Before describing in detail example embodiments, it is noted that the embodiments reside primarily in combinations of apparatus components and processing steps related to supporting enhanced mixup training for AI/ML processing of wireless signals. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate, and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio

Unit (RRU) Remote Radio Head(RRH), transmission/reception point (TRP), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

The term transmission/reception point (TRP) (also referred to as a transmit and receive point) used herein may refer to one or more of a base station, a network node, a gNB, eNB, etc., which may be configured as and/or which may comprise one or more TRPs. In some embodiments, a TRP may be an entity or a set of entities responsible for the transmission and reception of signals and data between the network and the WD. The TRP may be a physical or virtual instance of a base station or a network node, including next-generation Node B (gNB) or evolved Node B (eNB), radio head, etc., each of which can be configured as and/or may comprise one or more TRPs. A TRP may consist of one or more transmission/reception (Tx/Rx) elements, such as antennas, antenna ports, etc., which may be deployed in a variety of configurations based on the particular system.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped(LEE), laptop mounted equipment (LME), USB dongles, Customer Premises Equipment (CPE), an Internet of Things (IOT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head(RRH), TRP, etc.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband(UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

In some embodiments, the term “node” is used and may refer to any one of a network node, a management node, a wireless device, or elements/components of a system/network.

In some embodiments, the term “wireless signal measurement data” (or measurement data) is used and may refer to data associated with one or more wireless signals and that may be measured by one or more devices o nodes such as a node, network node, management node, a wireless device, etc. The wireless signals may include signals transmitted and/or received by any of the one or more devices o nodes. One or more parameters may be obtained or measured from the wireless signals and may include power, signal to noise ratio, amplitude, frequency, time domain parameters, etc. The parameters may be transformed into the data of the wireless signal measurement data.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide configurations for mixup training for AI/ML processing of wireless signals, e.g., where mixup training may be used as a data augmentation technique.

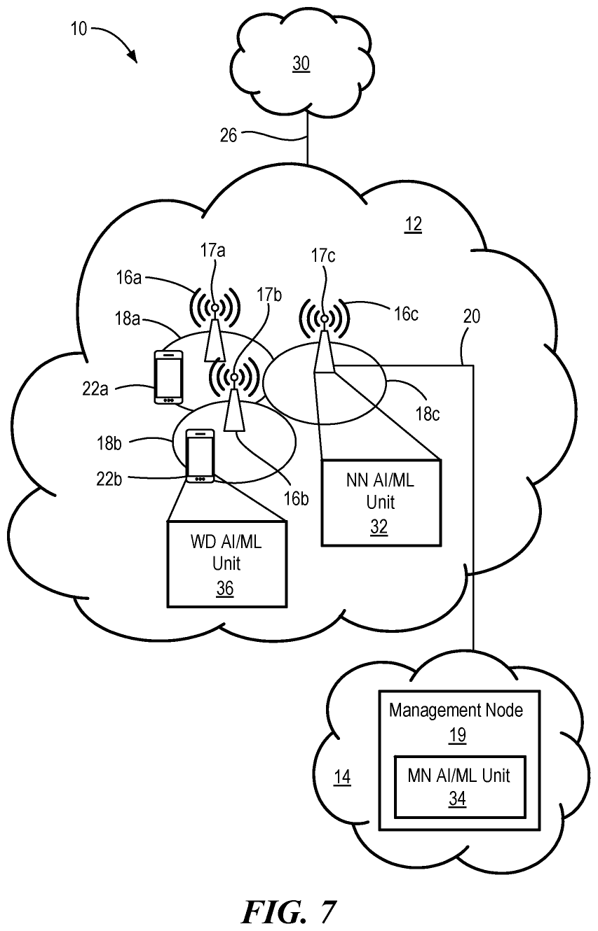

Referring again to the drawing figures, in which like elements are referred to by like reference numerals, there is shown in FIG. 7 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each network node 16 optionally including and/or corresponding to one or more corresponding transmission and reception points (TRPs) 17a, 17b, 17c (referred to collectively as TRPs 17), and each network node 16 defining a corresponding coverage area 18a, 18b, 18c (referred to collectively as coverage areas 18). The access network 12 and/or communication system 10 may further include a management node 19, which may be a type of network node 16, a core network 14 node, or another node, entity, server, etc., which is configured to communicate with and manage one or more network entities, such as network nodes 16, TRPs 17, etc. Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to network 30 and/or a host computer, which may be embodied in the hardware and/or software of a standalone server, a cloud-implemented server, a distributed server or as processing resources in a server farm. The host computer may be under the ownership or control of a service provider, or may be operated by the service provider or on behalf of the service provider. The network 30 may be one of, or a combination of more than one of, a public, private or hosted network. The network 30, if any, may be a backbone network or the Internet. In some embodiments, the network 30 may comprise two or more sub-networks (not shown), and any component of system 10 may be comprised in network 30.

A network node 16 is configured to include a network node (NN) AI/ML unit 32 which is configured to perform any step and/or task and/or process and/or method and/or feature described in the present disclosure such as support mixup training for AI/ML processing of wireless signals, by reporting wireless signaling data. A management node 19 is configured to include a management node (MN) AI/ML unit 34 which is configured to perform any step and/or task and/or process and/or method and/or feature described in the present disclosure such as support mixup training for AI/ML processing of wireless signals. A wireless device (WD) 22 is configured to include a WD AI/ML unit 36 which is configured to perform any step and/or task and/or process and/or method and/or feature described in the present disclosure, e.g., support mixup training for AI/ML processing of wireless signals, e.g., by reporting wireless signaling data.

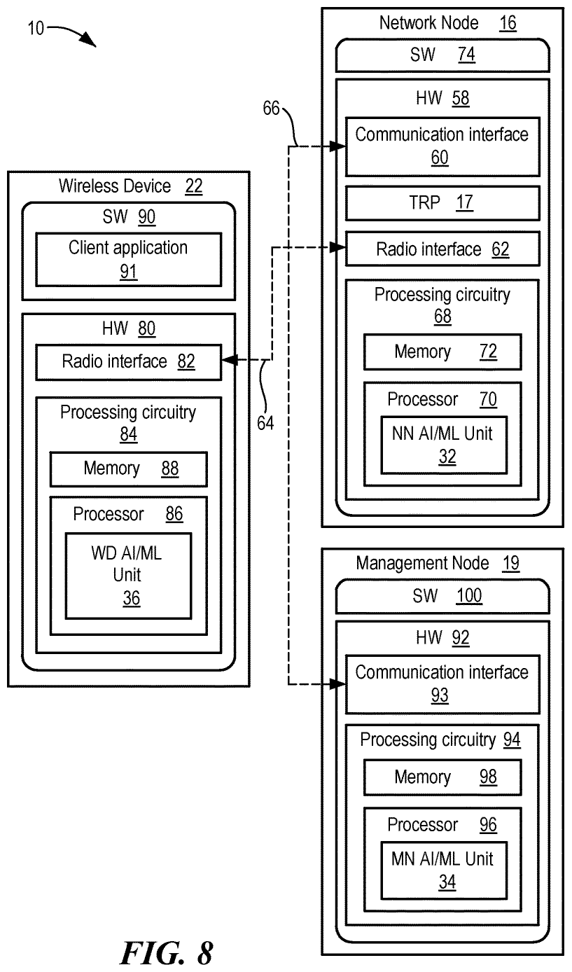

Example implementations, in accordance with an embodiment, of the WD 22, network node 16 and host computer 24 discussed in the preceding paragraphs will now be described with reference to FIG. 8.

The communication system 10 includes a network node 16, which may incorporate one or more TRP(s) 17, such as where the network node is a base station such as a gNB. The network node 16 includes hardware 58 enabling it to communicate with the management node 19, and with the WD 22.

The hardware 58 may include a communication interface 60 for setting up and maintaining a wired or wireless connection with an interface of a different communication device of the communication system 10. A radio interface 62, which could be formed as or include a TRP 17, is also part of the hardware 58. The radio interface 62 and/or TRP 17 may be configured for setting up and maintaining at least a wireless connection 64 with a WD 22 located in a coverage area 18 served by the network node 16. The radio interface 62 and/or TRP 17 may be formed as or may include, for example, one or more radio frequency (RF) transmitters, one or more RF receivers, and/or one or more RF transceivers.

The communication interface 60 may be configured to facilitate a connection 66 to the host computer 24 and/or management node 19, for example. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include NN AI/ML unit 32 configured to perform any step and/or task and/or process and/or method and/or feature described in the present disclosure.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 91. The client application 91 may be operable to provide a service to a human or non-human user via the WD 22. In providing the service to the user, the client application 91 may receive request data from the host application 50 and provide user data in response to the request data. The client application 91 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 91 may include instructions that, when executed by the processor 86 and/or processing circuitry 84, causes the processor 86 and/or processing circuitry 84 to perform the processes described herein with respect to WD 22.

The communication system 10 further includes a management node 19, which may be part of the access network 12, part of the core network 14, or may be separate from access network 12 and/or core network 14. The management node 19 is provided in a communication system 10 and includes hardware 92 enabling it to communicate with one or more network nodes 16 and/or any other entity in communication system 10.

The hardware 92 may include a communication interface 93 for setting up and maintaining a wired or wireless connection with an interface of a different communication device of the communication system 10.

The communication interface 93 may be configured to facilitate a connection 66 to network nodes 16. The connection 66 may be direct or it may pass through one or more networks such as a core network 14 of the communication system 10 and/or through one or more networks 30.

In the embodiment shown, the hardware 92 of the management node 19 further includes processing circuitry 94. The processing circuitry 94 may include a processor 96 and a memory 98. In particular, in addition to or instead of a processor, such as a central processing unit, and memory, the processing circuitry 94 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 96 may be configured to access (e.g., write to and/or read from) the memory 98, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the management node 19 further has software 100 stored internally in, for example, memory 98, or stored in external memory (e.g., database, storage array, network storage device, etc.) accessible by the management node 19 via an external connection. The software 100 may be executable by the processing circuitry 94. The processing circuitry 94 may be configured to control any of the methods and/or processes described herein and/or to cause such methods, and/or processes to be performed, e.g., by management node 19. Processor 96 corresponds to one or more processors 96 for performing management node 16 functions described herein. The memory 98 is configured to store data, programmatic software code and/or other information described herein. In some embodiments, the software 100 may include instructions that, when executed by the processor 96 and/or processing circuitry 94, causes the processor 96 and/or processing circuitry 94 to perform the processes described herein with respect to management node 19. For example, the processing circuitry 94 of the management node 19 may include a MN AI/ML unit 34 configured to perform any step and/or task and/or process and/or method and/or feature described in the present disclosure.

In some embodiments, the inner workings of the network node 16, management node 19, and WD 22 may be as shown in FIG. 8 and independently, the surrounding network topology may be that of FIG. 7.

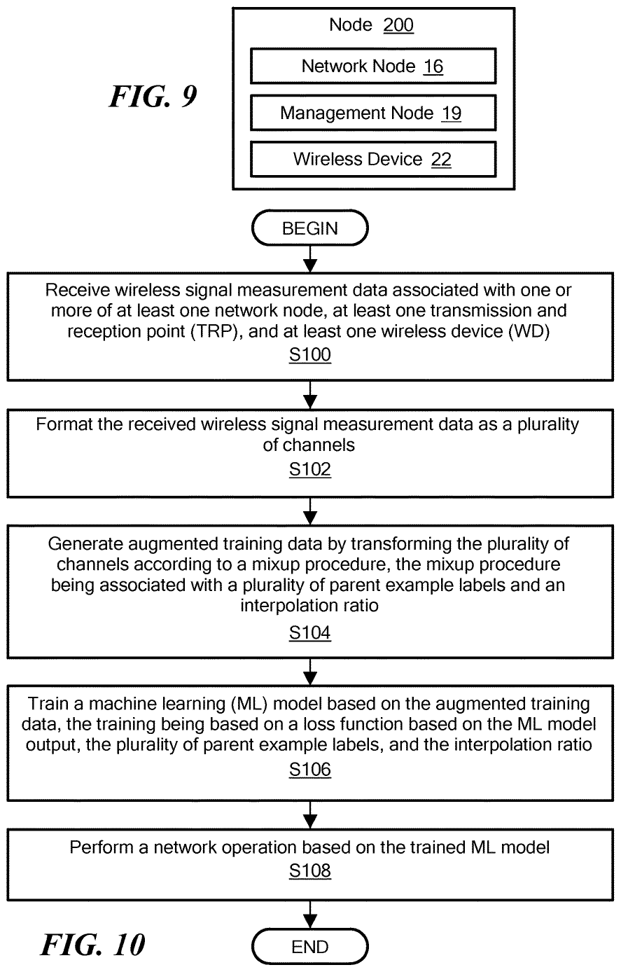

FIG. 9 shows an example node according to some embodiments of the present disclosure. Node 200 may be configured to perform any of the functions of and/or comprise one or more of network node 16, management node 19, and WD 22. That is, node 200 may be comprised in system 10 and/or comprise and/or be configured to perform any of the functions of any component and/or element of system 10.

In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16 (and/or management node 19).

Although FIGS. 7 and 8 show various “units” such as NN AI/ML unit 32, MN AI/ML unit 34, and WD AI/ML unit 36, as being within a respective processor, it is contemplated that these units may be implemented such that a portion of the unit is stored in a corresponding memory within the processing circuitry. In other words, the units may be implemented in hardware or in a combination of hardware and software within the processing circuitry.

FIG. 10 is a flowchart of an example process in a management node 19 according to some embodiments of the present disclosure for supporting mixup training for AI/ML processing of wireless signals. One or more blocks described herein may be performed by one or more elements of management node 19 such as by one or more of processing circuitry 94 (including the AI/ML unit 34), processor 96, and/or communication interface 93. Management node 19 is configured to receive (Block S100) wireless signal measurement data associated with one or more of at least one network node 16, at least one transmission and reception point (TRP) 17, and at least one WD 22. Management node 19 is configured to format (Block S102) the received wireless signal measurement data as a plurality of channels. In some embodiments or contexts, the data may already be formatted prior to receipt by the management node 19, in which case, this step may be optional. Management node 19 is configured to generate (Block S104) augmented training data by transforming the plurality of channels according to a mixup procedure, the mixup procedure being associated with a plurality of parent example labels and an interpolation ratio. For example, the dataset X may be transformed into dataset Y, and the combination of at least part of X and at least part of Y may form augmented dataset Z, which is used to train the machine learning model, as described herein. Management node 19 is configured to train (Block S106) a machine learning (ML) model based on (e.g., a function of) the augmented training data, the training being based on a loss function based on the ML model output, the plurality of parent example labels, and the interpolation ratio. Management node 19 is optionally configured to perform (Block S108) a network operation based on the trained ML model. For example, a WD location operation may be performed based on the trained ML model.

In some embodiments, the loss function corresponds to a linear interpolation of a plurality of losses associated with the model output and the plurality of parent example

In some embodiments, the plurality of parent example labels corresponds to a plurality of pairs of parent example labels, a pair of the plurality of pairs of parent example labels being selected randomly (e.g., by management node 19) with a pairing probability which is inversely proportional to a difference between a first element of the pair and a second element of the pair.

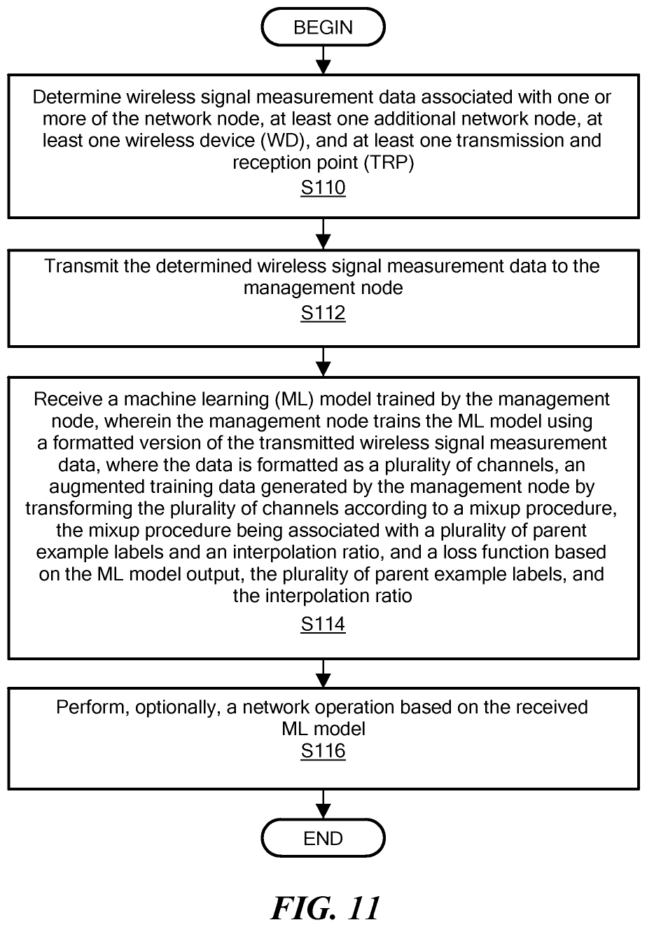

FIG. 11 is a flowchart of an example process in a network node 16 for supporting mixup training for AI/ML processing of wireless signals. One or more blocks described herein may be performed by one or more elements of network node 16 such as by one or more of processing circuitry 68 (including the NN AI/ML unit 32), processor 70, radio interface 62 and/or communication interface 60. Network node 16 is configured to determine (Block S110) wireless signal measurement data associated with one or more of the network node 16, at least one additional network node 16, at least one wireless device (WD) 22, and at least one transmission and reception point (TRP) 17. For example, the network node 16 may receive data which corresponds to measurements of signaling (e.g., data signaling, control signaling, reference signaling, etc.) and/or measurements of channel conditions (e.g., noise, interference, etc.), where the measurements are performed by the network node 16 itself and/or received from one or more other devices (other network nodes 16, TRPs 17 which are associated with the network node 16 and/or with other network nodes 16, from WDs 22, etc.). For example, the network node 16 may perform measurements of reference signaling transmitted by WDs 22. Network node 16 is configured to transmit (Block S112) the determined wireless signal measurement data to the management node 19. Network node 16 is configured to receive (Block S114) a machine learning (ML) model trained by the management node 19, wherein the management node trains the ML model using a formatted version of the transmitted wireless signal measurement data, where the data is formatted as a plurality of channels, an augmented training data generated by the management node by transforming the plurality of channels according to a mixup procedure, the mixup procedure being associated with a plurality of parent example labels and an interpolation ratio, and a loss function based on the ML model output, the plurality of parent example labels, and the interpolation ratio. Network node 16 is configured to perform (Block S116), optionally, a network operation based on the received trained ML model.

In some embodiments, the loss function corresponds to a linear interpolation of a plurality of losses associated with the model output and the plurality of parent example

In some embodiments, the plurality of parent example labels corresponds to a plurality of pairs of parent example labels, a pair of the plurality of pairs of parent example labels being selected randomly with a pairing probability which is inversely proportional to a difference between a first element of the pair and a second element of the pair.

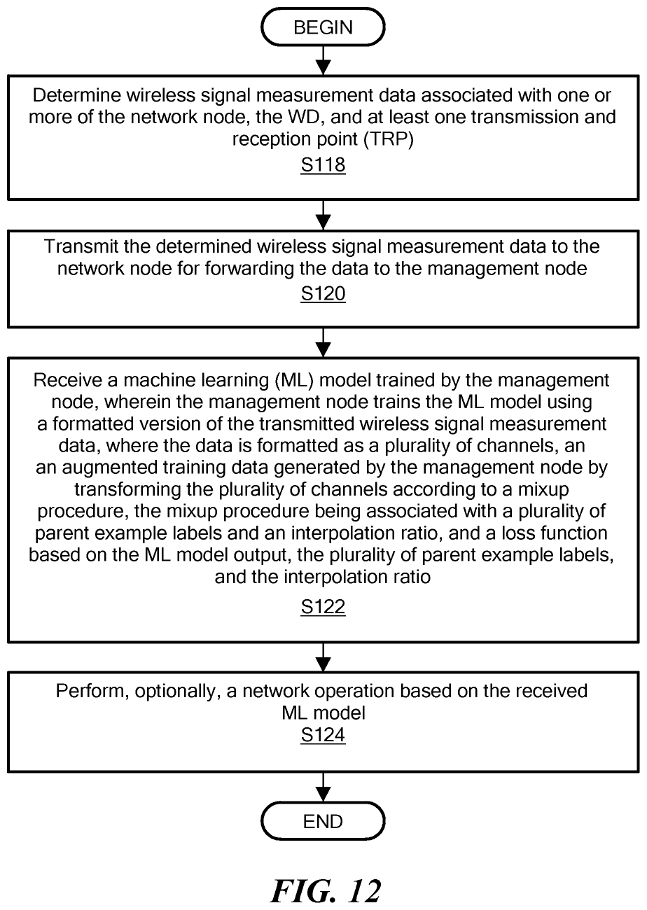

FIG. 12 is a flowchart of an example process in a wireless device (WD) 22 for supporting mixup training for AI/ML processing of wireless signals. One or more blocks described herein may be performed by one or more elements of WD 22 such as by one or more of processing circuitry 84 (including the WD AI/ML unit 36), processor 86, and/or radio interface 82. WD 22 is configured to determine (Block S118) wireless signal measurement data associated with one or more of the network node 16, the WD 22, and at least one transmission and reception point (TRP) 17. WD 22 is configured to transmit (Block S120) the determined wireless signal measurement data to the network node for forwarding the data to the management node 19. In general, the WD 22 may directly or indirectly transmit the measurement data to the management node 19 via one or more of the network node 16, TRP 17, core network 15, host computer 24, etc. WD 22 is configured to receive (Block S122) a machine learning (ML) model trained by the management node 19, wherein the management node 19 trains the ML model using a formatted version of the transmitted wireless signal measurement data, where the data is formatted as a plurality of channels, an augmented training data generated by the management node by transforming the plurality of channels according to a mixup procedure, the mixup procedure being associated with a plurality of parent example labels and an interpolation ratio, and a loss function based on the ML model output, the plurality of parent example labels, and the interpolation ratio. WD 22 is configured to perform (Block S124), optionally, a network operation based on the received trained ML model.

In some embodiments, the loss function corresponds to a linear interpolation of a plurality of losses associated with the model output and the plurality of parent example labels.

In some embodiments, the plurality of parent example labels corresponds to a plurality of pairs of parent example labels, a pair of the plurality of pairs of parent example labels being selected randomly with a pairing probability which is inversely proportional to a difference between a first element of the pair and a second element of the pair.

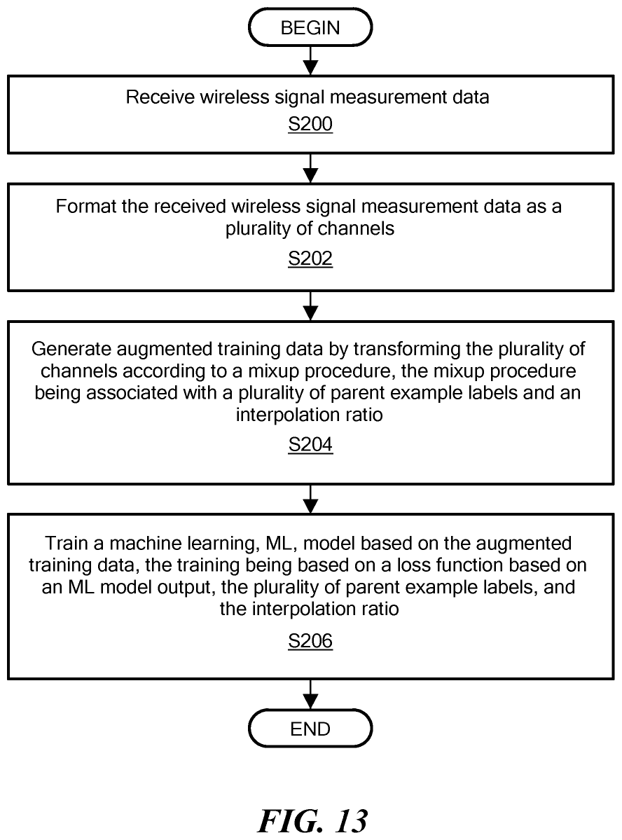

FIG. 13 is a flowchart of an example process in a node 200. One or more blocks described herein may be performed by one or more elements of node 200 such as network node 16, management node 19, and/or WD 22. In some embodiments, node 200 includes a network node 16 and blocks described herein may be performed by one or more elements of network node 16 such as one or more of processing circuitry 68 (including NN AI/ML unit 32), processor 70, radio interface 62 and/or communication interface 60. In some other embodiments, node 200 includes a management node 19 and blocks described herein may be performed by one or more elements of management node 19 such as one or more of processing circuitry 94 (including the MN AI/ML unit 34), processor 96, and/or communication interface 93. In some embodiments, node 200 includes a WD 22 and blocks described herein may be performed by one or more of processing circuitry 84 (including the WD AI/ML unit 36), processor 86, and/or radio interface 82. Node 200 may be configured to receive (Block S200) wireless signal measurement data, format (Block S202) the received wireless signal measurement data as a plurality of channels, generate (Block S204) augmented training data by transforming the plurality of channels according to a mixup procedure. The mixup procedure is associated with a plurality of parent example labels and an interpolation ratio. In addition, the node is configured to train (Block S206) a machine learning (ML) model based on the augmented training data. The training is based on a loss function based on an ML model output, the plurality of parent example labels, and the interpolation ratio.

In some embodiments, the wireless signal measurement data is associated with one or more of at least one network node 16, at least one transmission and reception point (TRP) 17, and at least one wireless device 22.

In some other embodiments, the received wireless signal measurement data includes at least a wireless signal sample, and formatting the received wireless signal measurement data includes formatting the at least wireless signal sample based on a two-dimensional data representation comprising at least three parameters.

In some embodiments, the at least three parameters includes a first parameter, a second parameter, and a third parameter. The first parameter corresponds to a plurality of time domain taps, the second parameter corresponds to a plurality of transmission and reception points (TRPs) 17, and the third parameter corresponds to a quantity of channels of the plurality of channels.

In some other embodiments, formatting the received wireless signal measurement data includes combining two of the at least three parameters and obtaining a single-dimension data representation using the combination.

In some embodiments, the loss function corresponds to a linear interpolation of a plurality of losses associated with the ML model output and the plurality of parent example labels.

In some other embodiments, the plurality of parent example labels corresponds to a plurality of pairs of parent example labels, and generating augmented training includes randomly selecting a pair of the plurality of pairs of parent example labels with a pairing probability. The pairing probability is inversely proportional to a difference between a first element of the pair and a second element of the pair.

In some embodiments, generating augmented training further includes one or more of determining the interpolation ratio, where the interpolation ratio being a random interpolation ratio λ, determining a mixup input, ã, determining a model output, ŷ, from the ML model using the mixup input, determining the loss function as a function of the model output, ŷ, a first parent example label, yᵢ, and a second parent example label, yⱼ, and the random interpolation ratio λ, and determining adjustments to one or more parameters of ML model to reduce loss.

In some other embodiments, a loss associated with the loss function is a linear interpolation of losses individually considering the model output and at least one parent example label.

In some embodiments, the method further includes performing at least one action based on the trained ML model.

In some other embodiments, the node 200 is one of a network node 16, a management node 19, and a wireless device 22.

Having described the general process flow of arrangements of the disclosure and having provided examples of hardware and software arrangements for implementing the processes and functions of the disclosure, the sections below provide details and examples of arrangements for supporting mixup training (e.g., as a data augmentation technique) for AI/ML processing of wireless signals. Any step and/or task and/or process and/or method and/or feature described herein may be performed by any of the components of system 10 such as network node 16, management node 19, and/or WD 22.

Some embodiments of the present disclosure provide configurations for a management node 19 applying independent operations along a specific dimension of wireless signal data representation, e.g., based on wireless signal data received from and/or generated by and/or reported by one or more network nodes 16 (e.g., TRPs 17) and/or WDs 22. These operations may enable relevant wireless signal physical meaning/information to be preserved while yielding a wide range of variations on the same wireless signal data sample. Such physical meaning/information preserving operations may allow the AI/ML models, e.g., as implemented in management node 19 and/or node 200, to see (e.g., learn) a wide range of variations on the same physical embodiments, such that the AI/ML models may be trained to achieve very high performance.

In some embodiments, representing the wireless signal sample data in a format for ML/AI model training may include, for example, management node 19 (e.g., via processing circuitry 94 and/or MN AI/ML unit 34) and/or node 200 being configured to perform one or more processing operations on wireless signal sampling information (e.g., data received from network nodes 16 and/or TRPs 17) to convert the data into a format suitable for AI/ML model training. In some embodiments, one or more of the conversion steps may be performed in a network node 16 and/or node 200, e.g., prior to the processed (or partially processed) data being transmitted to the management node 19. In some embodiments, a mixup training may be performed, as described herein.

In the embodiments described herein, network nodes 16, TRPs 17, WDs 22, and/or node 200, etc., may be configured to report wireless signal sampling data, measurement data, reference signaling data, etc., to the management node 19. The reporting may, in some embodiments, occur via one or more intermediate devices, such as additional network nodes 16, core network 14 nodes, etc.

### Example Embodiments for a Position Generation Entity

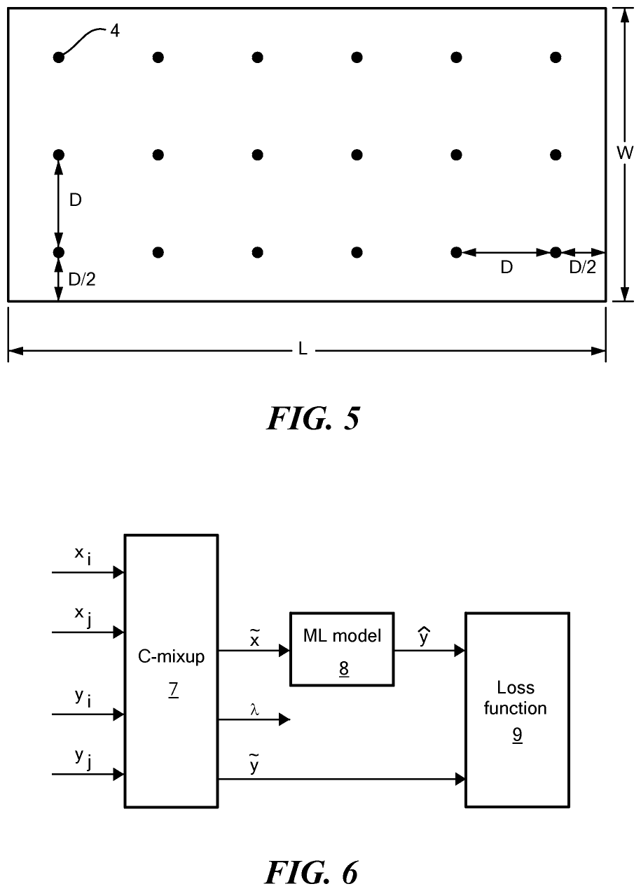

As described herein, WD positioning based on wireless signals is used as a nonlimiting representative example of applying AI/ML models to process wireless signals according to one or more embodiments of the present disclosure. Thus, any specifics described herein referring to the 3GPP indoor factory (InF) positioning use case, for example, as illustrated in the schematic diagram of FIG. 5, may be understood as a nonlimiting example for illuminating various aspects of the teachings herein. It is to be understood that embodiments of the present disclosure may also be applied to other wireless signal processing or modeling problems, applications, etc.

Most modern neural network based deep learning AI/ML approaches originate from the computer vision field. Tools and nomenclature from the computer vision field may be adopted herein as a way of communicating modern deep learning models. More specifically, a canonical data presentation may be based on what an image is, e.g.:
A single “2D data” (i.e., two-dimension data) includes three dimensions: W×H×C for the width, height and(color) channel dimensions.
A batch of “2D data” includes four dimensions: BxW×H×C for the batch, width, height and(color) channel dimensions.

The “channel” dimension nomenclature originated from the color channels of an image. However, “channel” in the present disclosure may refer to a data channel such as wireless data channel which may include data from one or more components of system 10 (such as TRP 17). For example, a channel may refer to a specific division of resources such as frequencies in a specific wireless band. In addition, the term channel may be used as a term in deep learning to represent more general aspects of the data, particularly after the data has been passed through the deep learning models.

These “2D data” representations may also be extended to include “1D data” or “3D data” representations. More specifically, for “1D data”, there may be:
A single “1D data” including two dimensions: WxC for the width and channel dimensions.
A batch of “1D data” including three dimensions: BxWxC for the batch, width and channel dimensions.

For a wireless signal processing use case to reuse the tools and modeling architectures developed for the computer vision field, it may be necessary to fit the wireless signal data to such canonical “1D data” or “2D data” representations, in some embodiments.

In a first approach according to some embodiments described herein, a wireless signal sample may be treated(e.g., by management node 19 and/or network nodes 16 and/or node 200) according to a “2D data” representation. For example, the aforementioned received signal from one or more (e.g., a quantity of 18) network nodes 16 (and/or TRPs 17), each with (for example) 2 antenna ports, may be treated(e.g., by management node 19) as “2D data” with dimensions, e.g., of 256×18×2. That is, the width in this example corresponds to 256 time domain taps, height corresponds to 18 network nodes 16 (TRPs 17), and the number of channels is 2. If the aforementioned received signal is a complex CIR sample and the AI/ML model (e.g., implemented in management node 19) cannot process complex values directly, for example, then the received signal sample data from network nodes 16 (TRPs 17) may be represented as a 256×18×4 “2D data”. In some embodiments, the received signal sample data may also/alternatively be received from any number of WDs 22 or other types of devices or nodes of system 10.

In a second approach, the network node 16 (TRP 17) and the antenna dimensions may be combined to obtain a “1D data” representation for the aforementioned received signal as 256×36. That is, width corresponds to 256 time domain taps and the number of channels is 36. Similarly, for complex CIR and real-valued models, the representation may be a 256×72 “1D data”. It is to be understood that these arrangements are examples, and that other numerologies and configurations may be used without deviating from the scope of the present disclosure. Further, this embodiment/approach may be applied to other sources of wireless signal data, e.g., WDs 22.

According a first example embodiment of the present disclosure, the loss function, e.g., as computed by MN AI/ML unit 34, in a mixup training procedure, may depend on at least:
The model output ŷ
The parent example labels yᵢ and yⱼ
The interpolation ratio λ

That is, the enhanced loss function [symbol] [symbol] takes the form of

$${ℒ}_{E} ( \hat{y} , {y}_{i} , {y}_{j} , λ )$$

The model output ŷ may refer to the output of the machine learning model 112. The parent example labels yᵢ and yⱼ may refer to labels corresponding to xᵢ, xⱼ, respectively, which are two inputs to c-mixup 10 (configured to perform a c-mixup training/algorithm/process). The interpolation ratio λ may refer to a ratio that is used for mixup input and mixup target. The interpolation ratio may be a random interpolation ratio that is drawn from a Beta distribution.

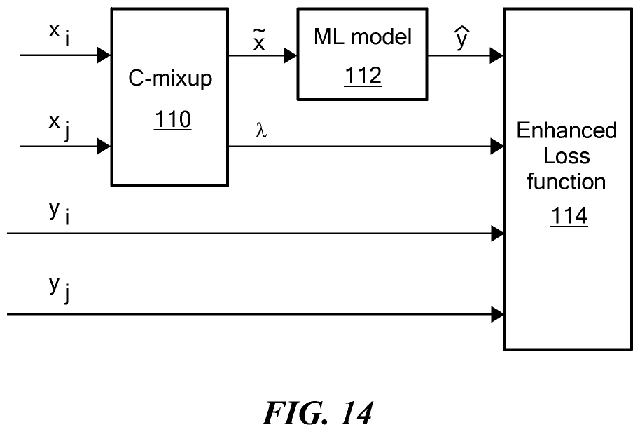

FIG. 14 illustrates an example training procedure performed by a management node 19 and/or node 200, e.g., a “c-mixup-plus” procedure, according to some embodiments of the present disclosure. Inputs xᵢ, xⱼ are provided to C-mixup 110, which outputs a mixup input \tilde{x} provided as an input to the ML model 112. ML model 112 outputs ŷ, e.g., using the mixup input. C-mixup 110 also outputs interpolation ratio λ, which is provided as an input to the enhanced loss function 114. Parent example labels yᵢ and yⱼ are provided as inputs to enhanced loss function 114.

According to a second example embodiment, an enhanced loss function, e.g., as implemented in a management node 19 and/or MN AI/ML unit 34 and/or node 200 and/or any of its units, for a mixup training procedure, may be a linear interpolation of the losses considering the output and the parent example labels individually. As a nonlimiting example embodiment, the enhanced loss function may be computed as:

$${ℒ}_{E} ( \hat{y} , {y}_{i} , {y}_{j} , λ ) = λ \cdot ℒ ( \hat{y} , {y}_{i} ) + ( 1 - λ ) \cdot ℒ ( \hat{y} , {y}_{j} )$$

where the baseline loss function [symbol] (ŷ, y) measures the distance between ŷ and y.

As one nonlimiting example embodiment, the baseline loss function [symbol] may be a mean square error distance (as known as L2 distance), e.g., according to:

$$ℒ ( \hat{y} , y ) {=}^{Δ} {\sum }_{k = 1}^{n} {\vert \hat{y} [ k ] - y [ k ] \vert}^{2}$$

In some embodiments of the present disclosure, a mean absolute deviation distance (also known as the L1 distance) may result in improved machine learning model performance over existing techniques, e.g., according to:

$$ℒ ( \hat{y} , y ) {=}^{Δ} {\sum }_{k = 1}^{n} \vert \hat{y} [ k ] - y [ k ] \vert$$

In general, the baseline loss function [symbol] may be a higher order distance function, such as:

$$ℒ ( \hat{y} , y ) {=}^{Δ} {\sum }_{k = 1}^{n} {\vert \hat{y} [ k ] - y [ k ] \vert}^{p}$$

where p is a positive value.

In some embodiments, an enhanced loss function may force the machine learning model to learn improved outputs that are closer to the correct parent example labels.

In summary, according to some embodiments of the present disclosure, a “c-mixup-plus” mixup training/data augmentation operation, e.g., as implemented in a management node 19 and/or MN AI/ML unit 34 and/or node 200 and/or any of its units, may include one or more of the following steps performed iteratively/repeatedly, e.g., for different training data samples (e.g., data which is received/collected/reported by network nodes 16, TRPs 17, WDs 22, and/or node 200etc.):
Select a pair of parent examples randomly with pairing probability inversely proportional to their differences.
Determine a random interpolation ratio λ.
Determine a mixup input \tilde{x}.
Determine a model output ŷ from a machine learning model using the mixup input \tilde{x}.
Determine a loss as a function of the model output ŷ, the parent example labels yᵢ and yⱼ, and the interpolation ratio λ.
   More specifically, the loss may be a linear interpolation of the losses considering the output and the parent example labels individually.
Determine adjustments to the parameters of machine learning model to reduce the loss.

In some embodiments, unlike some existing c-mixup techniques, there may be no need to generate a mixup target \tilde{y}, e.g., since it may not be needed for some embodiments of the present disclosure, e.g., c-mixup-plus. This feature is illustrated in the example of FIG. 14.

### Nonlimiting Example Demonstration of Utility of the Embodiments

Some embodiments of the present disclosure may be implemented in a 3GPP indoor factory (InF) model, e.g., as illustrated in FIG. 5. It is to be understood that this is a nonlimiting example, and embodiments of the present disclosure may be applied to a variety settings. In the example scenario of FIG. 5, 18 TRPs 17 (and/or network nodes 16) may be deployed in a factory or similar indoor setting, with TRP 17/network node 16 locations known at the network (e.g., by management node 19 and/or node 200). For example, with 60% clutter density and clutter height and width of 6 m and 2 m, respectively, this example indoor factory scenario has less than 1% LoS probability from a WD 22 to any TRPs 17 (network nodes 16). This example environment is referred to as the “InF-DH {60%, 6m, 2m} environment,” below.

It may be assumed, in some cases and some embodiments, that the WD 22 is requested to transmit an uplink signal, e.g., sounding reference signal (SRS), using, e.g., the existing standard NR air-interface. This signal may be received by multiple network nodes 16 (e.g., gNBs, TRPs 17, etc.), e.g., at known positions, to produce channel impulse response (CIR) inputs (or similar wireless signaling/measurement data) for the machine learning model.

To demonstrate the performance of an example data mixing and/or data augmentation technique described herein, a simulation was performed, training a same deep neural network machine learning model with five different variations of the same dataset, containing 1000 training samples, according to:
Technique #1 no data augmentation.
Technique #2 c-mixup.
Technique #3 c-mixup-plus (e.g., according to one or more embodiments of the present disclosure).
Technique #4 random channel shifting and dropping.
Technique #5 c-mixup-plus (e.g., according to one or more embodiments of the present disclosure)+random channel shifting and dropping.

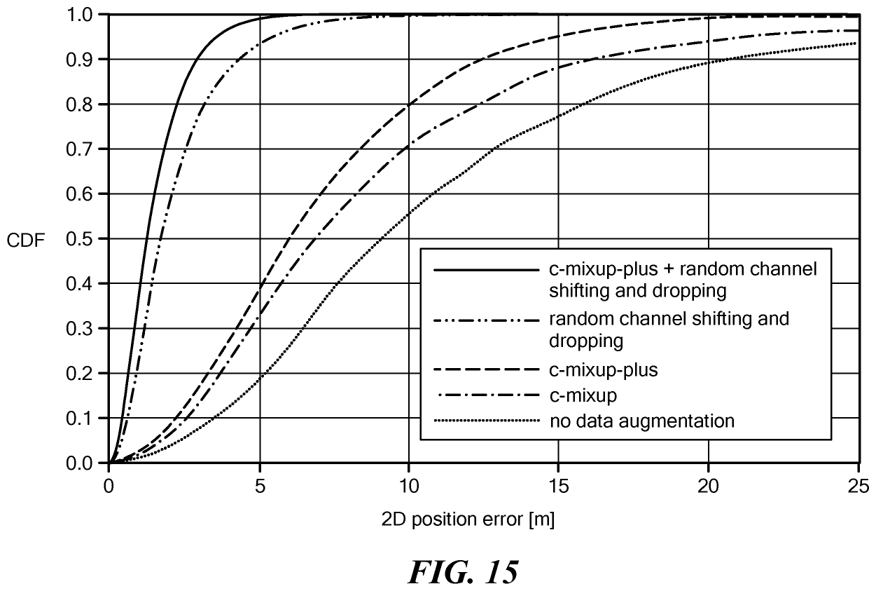

FIG. 15 illustrates an example Cumulative distribution function of 2D position error of the same model trained with different data augmentation techniques.

As illustrated in FIG. 15, c-mixup-plus according to some embodiments of the present disclosure may outperform existing c-mixup training techniques. More specifically,
Without data augmentation, the WD position error is up to 21 m for 90% of the time. This is referred to as the 90-percentile positioning error.
With existing c-mixup training techniques, the 90-percentile positioning error is reduced to 16.5 m.
Using techniques according to some embodiments of the present disclosure, c-mixup-plus may further reduce the 90-percentile positioning error to 12.8 m, which is almost half of the errors when no data augmentation is used. As shown in FIG. 15 and Table 1, below, c-mixup-plus may achieve improved accuracy over existing techniques at all percentile points. For the critical 90-percentile positioning error criterion, techniques according to embodiments of the present disclosure, e.g., c-mixup-plus, may almost double the positioning error reduction achieved by existing systems.
Embodiments of the present disclosure, e.g., c-mixup-plus, may also be combined with other data augmentation techniques to further improve WD positioning accuracy. For instance, with Technique #4 (which is itself a combination of two effective data augmentation techniques), the 90-percentile positioning error is already at a very low level of 4.3 m. However, by applying techniques according to embodiments of the present disclosure, e.g., c-mixup-plus, in addition to the Technique #4, one may further reduce the 90-percentile positioning error to 3 m.

Note that, for all cases in this example, there are only 1000 labeled data, and the data augmentation techniques may drastically increase the variety of channel conditions for the model learning models to learn improved positioning accuracy. With the combination of c-mixup-plus and random channel shifting and dropping, embodiments of the present disclosure may be able to reduce the 90-percentile positioning error by 85%, from 21 m to 3 m.

Further, FIG. 15 illustrates an example cumulative distribution function (CDF) of 2D position error of the same model trained with different data augmentation and/or data mixup training techniques. The baseline dataset contains 1000 samples of {60%, 6m, 2m} InF-DH environment.

Table 1, below, illustrates example simulation results for WD 2D positioning
errors in meters for an InF-DH {60%, 6 m, 2 m} test dataset at
different percentiles and 5 different data augmentation/data mixup training
techniques, according to some embodiments of the present disclosure.

| | | | | | Technique |
|---|---|---|---|---|---|
| | | | | | #5 |
| | | | | | c-mixup- |
| | | | | | plus (e.g., |
| | | | | | according |
| | | | Technique | | to some |
| | | | #3 | | embodiments |
| | | | c-mixup- | | of the |
| | | | plus (e.g., | Technique | present |
| | | | according | #4 | disclosure) + |
| | | | to some | random | random |
| | Technique | | embodiments | channel | channel |
| | #1 | Technique | of the | shifting | shifting |
| CDF | No data | #2 | present | and | and |
| Percentile | augmentation | c-mixup | disclosure) | dropping | dropping |
| 50 | 9.218 | 6.951 | 6.103 | 1.761 | 1.354 |
| 67 | 12.325 | 9.403 | 7.955 | 2.440 | 1.814 |
| 80 | 15.861 | 12.449 | 10.224 | 3.241 | 2.391 |
| 90 | 21.075 | 16.452 | 12.809 | 4.328 | 3.039 |

The following is a nonlimiting list of example embodiments.

Embodiment A1. A management node configured to communicate with one or both of a wireless device (WD) and a network node, the management node configured to, and/or comprising a radio interface and/or comprising processing circuitry configured to:
receive wireless signal measurement data associated with one or more of:
   at least one network node;
   at least one transmission and reception point (TRP); and
   at least one WD;
format the received wireless signal measurement data as a plurality of channels;
generate augmented training data by transforming the plurality of channels according to a mixup procedure, the mixup procedure being associated with a plurality of parent example labels and an interpolation ratio;
train a machine learning (ML) model based on the augmented training data, the training being based on a loss function based on:
   the ML model output;
   the plurality of parent example labels; and
   the interpolation ratio; and
optionally, perform a network operation based on the trained ML model.

Embodiment A2. The management node of Embodiment A1, wherein the loss function corresponds to a linear interpolation of a plurality of losses associated with the model output and the plurality of parent example labels.

Embodiment A3. The management node of any one of Embodiments A1 and A2, wherein the plurality of parent example labels corresponds to a plurality of pairs of parent example labels, a pair of the plurality of pairs of parent example labels being selected randomly with a pairing probability which is inversely proportional to a difference between a first element of the pair and a second element of the pair.

Embodiment B1. A method implemented in a management node, the method comprising:
receiving wireless signal measurement data associated with one or more of:
   at least one network node;
   at least one transmission and reception point (TRP); and
   at least one WD;
formatting the received wireless signal measurement data as a plurality of channels;
generate augmented training data by transforming the plurality of channels according to a mixup procedure, the mixup procedure being associated with a plurality of parent example labels and an interpolation ratio;
train a machine learning (ML) model based on the augmented training data, the training being based on a loss function based on:
   the ML model output;
   the plurality of parent example labels; and
   the interpolation ratio; and
optionally, performing a network operation based on the trained ML model.

Embodiment B2. The method of Embodiment B1, wherein the loss function corresponds to a linear interpolation of a plurality of losses associated with the model output and the plurality of parent example labels.

Embodiment B3. The method of any one of Embodiments B1 and B2, wherein the plurality of parent example labels corresponds to a plurality of pairs of parent example labels, a pair of the plurality of pairs of parent example labels being selected randomly with a pairing probability which is inversely proportional to a difference between a first element of the pair and a second element of the pair.

Embodiment C1. A network node configured to communicate with one or both of a wireless device and a management node, the network node configured to, and/or comprising a radio interface and/or processing circuitry configured to:
determine wireless signal measurement data associated with one or more of:
   the network node;
   at least one additional network node;
   at least one wireless device (WD); and
   at least one transmission and reception point (TRP);
transmit the determined wireless signal measurement data to the management node;
receive a machine learning (ML) model trained by the management node, the management node training the ML model using:
   a formatted version of the transmitted wireless signal measurement data, where the data is formatted as a plurality of channels;
   an augmented training data generated by the management node by transforming the plurality of channels according to a mixup procedure, the mixup procedure being associated with a plurality of parent example labels and an interpolation ratio; and
   a loss function based on:
      the ML model output;
   the plurality of parent example labels; and
   the interpolation ratio; and
perform, optionally, a network operation based on the received trained ML model.

Embodiment C2. The network node of Embodiment C1, wherein the loss Embodiment C2. function corresponds to a linear interpolation of a plurality of losses associated with the model output and the plurality of parent example labels.

Embodiment C3. The network node of any one of Embodiments C1 and C2, wherein the plurality of parent example labels corresponds to a plurality of pairs of parent example labels, a pair of the plurality of pairs of parent example labels being selected randomly with a pairing probability which is inversely proportional to a difference between a first element of the pair and a second element of the pair.

Embodiment D1. A method implemented in a network node, the method comprising:
determining wireless signal measurement data associated with one or more of:
   the network node;
   at least one additional network node;
   at least one wireless device (WD); and
   at least one transmission and reception point (TRP);
transmitting the determined wireless signal measurement data to the management node;
receiving a machine learning (ML) model trained by the management node, the management node training the ML model using:
   a formatted version of the transmitted wireless signal measurement data, where the data is formatted as a plurality of channels;
   an augmented training data generated by the management node by transforming the plurality of channels according to a mixup procedure, the mixup procedure being associated with a plurality of parent example labels and an interpolation ratio; and
   a loss function based on:
      the ML model output;
      the plurality of parent example labels; and
      the interpolation ratio; and; and
performing, optionally, a network operation based on the received trained ML model.

Embodiment D2. The method of Embodiment D1, wherein the wherein the loss function corresponds to a linear interpolation of a plurality of losses associated with the model output and the plurality of parent example labels.

Embodiment D3. The method of any one of Embodiments D1 and D2, wherein the plurality of parent example labels corresponds to a plurality of pairs of parent example labels, a pair of the plurality of pairs of parent example labels being selected randomly with a pairing probability which is inversely proportional to a difference between a first element of the pair and a second element of the pair.

Embodiment E1. A wireless device configured to communicate with one or both of a network node and a management node, the wireless device configured to, and/or comprising a radio interface and/or processing circuitry configured to:
determine wireless signal measurement data associated with one or more of:
   the network node;
   the wireless device (WD); and
   at least one transmission and reception point (TRP);
transmit the determined wireless signal measurement data to the network node for forwarding the data to the management node;
receive a machine learning (ML) model trained by the management node, the management node training the ML model using:
   a formatted version of the transmitted wireless signal measurement data, where the data is formatted as a plurality of channels;
   an augmented training data generated by the management node by transforming the plurality of channels according to a mixup procedure, the mixup procedure being associated with a plurality of parent example labels and an interpolation ratio; and
   a loss function based on:
      the ML model output;
      the plurality of parent example labels; and
      the interpolation ratio; and; and
perform, optionally, a network operation based on the received trained ML model.

Embodiment E2. The wireless device of Embodiment E1, wherein the wherein the loss function corresponds to a linear interpolation of a plurality of losses associated with the model output and the plurality of parent example labels.

Embodiment E3. The wireless device of any one of Embodiments E1 and |E2, wherein the plurality of parent example labels corresponds to a plurality of pairs of parent example labels, a pair of the plurality of pairs of parent example labels being selected randomly with a pairing probability which is inversely proportional to a difference between a first element of the pair and a second element of the pair.

Embodiment F1. A method implemented in a wireless device, the method comprising:
determining wireless signal measurement data associated with one or more of:
   the network node;
   the wireless device (WD); and
   at least one transmission and reception point (TRP);
transmitting the determined wireless signal measurement data to the network node for forwarding the data to the management node;
receiving a machine learning (ML) model trained by the management node, the management node training the ML model using:
   a formatted version of the transmitted wireless signal measurement data, where the data is formatted as a plurality of channels;
   an augmented training data generated by the management node by transforming the plurality of channels according to a mixup procedure, the mixup procedure being associated with a plurality of parent example labels and an interpolation ratio; and
   a loss function based on:
      the ML model output;
      the plurality of parent example labels; and
      the interpolation ratio; and; and
performing, optionally, a network operation based on the received trained ML model.

Embodiment F2. The method of Embodiment F1, wherein the wherein the loss function corresponds to a linear interpolation of a plurality of losses associated with the model output and the plurality of parent example labels.

Embodiment F3. The method of any one of Embodiments F1 and F2, wherein the plurality of parent example labels corresponds to a plurality of pairs of parent example labels, a pair of the plurality of pairs of parent example labels being selected randomly with a pairing probability which is inversely proportional to a difference between a first element of the pair and a second element of the pair.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a node associated with a network, the method comprising:
receiving wireless signal measurement data;
formatting the received wireless signal measurement data as a plurality of channels;
generating augmented training data by transforming the plurality of channels according to a mixup procedure, the mixup procedure being associated with a plurality of parent example labels and an interpolation ratio; and
training a machine learning, ML, model based on the augmented training data, the training being based on a loss function based on:
an ML model output;
the plurality of parent example labels; and
the interpolation ratio.

2. The method of claim 1, wherein the wireless signal measurement data is associated with one or more of:
at least one network node;
at least one transmission and reception point, TRP; and
at least one wireless device.

3. The method of claim 1, wherein the received wireless signal measurement data includes at least a wireless signal sample, and formatting the received wireless signal measurement data includes:
formatting the at least wireless signal sample based on a two-dimensional data representation comprising at least three parameters.

4. The method of claim 3, wherein the at least three parameters includes a first parameter, a second parameter, and a third parameter, the first parameter corresponds to a plurality of time domain taps, the second parameter corresponds to a plurality of transmission and reception points, TRPs, and the third parameter corresponds to a quantity of channels of the plurality of channels.

5. The method of claim 3, wherein formatting the received wireless signal measurement data includes:
combining two of the at least three parameters; and
obtaining a single-dimension data representation using the combination.

6. The method of claim 1, wherein the loss function corresponds to a linear interpolation of a plurality of losses associated with the ML model output and the plurality of parent example labels.

7. The method of claim 1, wherein the plurality of parent example labels corresponds to a plurality of pairs of parent example labels, and generating augmented training includes:
randomly selecting a pair of the plurality of pairs of parent example labels with a pairing probability, the pairing probability being inversely proportional to a difference between a first element of the pair and a second element of the pair.

8. The method of claim 7, wherein generating augmented training further includes one or more of:
determining the interpolation ratio, the interpolation ratio being a random interpolation ratio λ;
determining a mixup input, \tilde{x};
determining a model output, ŷ, from the ML model using the mixup input, \tilde{x};
determining the loss function as a function of the model output, ŷ, a first parent example label, yᵢ, and a second parent example label, yⱼ, and the random interpolation ratio λ; and
determining adjustments to one or more parameters of ML model to reduce loss.

9. The method of claim 8, wherein a loss associated with the loss function is a linear interpolation of losses individually considering the model output and at least one parent example label.

10. The method of claim 1, wherein the method further includes:
performing at least one action based on the trained ML model.

11. The method of claim 1, wherein the node is one of:
a network node;
a management node; and
a wireless device.

12. A node associated with a network, the node being configured to:
receive wireless signal measurement data;
format the received wireless signal measurement data as a plurality of channels;
generate augmented training data by transforming the plurality of channels according to a mixup procedure, the mixup procedure being associated with a plurality of parent example labels and an interpolation ratio; and
train a machine learning, ML, model based on the augmented training data, the training being based on a loss function based on:
an ML model output;
the plurality of parent example labels; and
the interpolation ratio.

13. The node of claim 12, wherein the wireless signal measurement data is associated with one or more of:
at least one network node;
at least one transmission and reception point, TRP; and
at least one wireless device.

14. The node of claim 12, wherein the received wireless signal measurement data includes at least a wireless signal sample, and formatting the received wireless signal measurement data includes:
formatting the at least wireless signal sample based on a two-dimensional data representation comprising at least three parameters.

15. The node of claim 14, wherein the at least three parameters includes a first parameter, a second parameter, and a third parameter, the first parameter corresponds to a plurality of time domain taps, the second parameter corresponds to a plurality of transmission and reception points, TRPs, and the third parameter corresponds to a quantity of channels of the plurality of channels.

16. The node of claim 14, wherein formatting the received wireless signal measurement data includes:
combining two of the at least three parameters; and
obtaining a single-dimension data representation using the combination.

17. The node of claim 12, wherein the loss function corresponds to a linear interpolation of a plurality of losses associated with the ML model output and the plurality of parent example labels.

18. The node of claim 12, wherein the plurality of parent example labels corresponds to a plurality of pairs of parent example labels, and generating augmented training includes:
randomly selecting a pair of the plurality of pairs of parent example labels with a pairing probability, the pairing probability being inversely proportional to a difference between a first element of the pair and a second element of the pair.

19. The node of claim 18, wherein generating augmented training further includes one or more of:
determining the interpolation ratio, the interpolation ratio being a random interpolation ratio λ;
determining a mixup input, \tilde{x};
determining a model output, ŷ, from the ML model using the mixup input, \tilde{x};
determining the loss function as a function of the model output, ŷ, a first parent example label, yᵢ, and a second parent example label, yⱼ, and the random interpolation ratio λ; and
determining adjustments to one or more parameters of ML model to reduce loss.

20. The node of claim 19, wherein a loss associated with the loss function is a linear interpolation of losses individually considering the model output and at least one parent example label.

21. (canceled)

22. (canceled)
